(19) United States
(12) Patent Application Publication
(10) Pub. No.: US 2025/0254341 A1
(43) Pub. Date: Aug. 7, 2025

(54) CHROMA DIRECT MODE

(71) Applicant: InterDigital CE Patent Holdings, SAS, Paris (FR)

(72) Inventors: Karam Naser, Mouazé (FR); Kevin Reuzé, Rennes (FR); Thierry Dumas, Rennes (FR); Tangi Poirier, Thorigné-Fouillard (FR)

(73) Assignee: InterDigital CE Patent Holdings, SAS, Paris (FR)

(21) Appl. No.: 18/855,152

(22) PCT Filed: Apr. 4, 2023
(86) PCT No.: PCT/EP2023/058871

§ 371 Date: Oct. 8, 2024

(30) Foreign Application Priority Data
Apr. 8, 2022 (EP) 22305489.1
Dec. 23, 2022 (EP) 22307025.1

(51) Int. Cl. H04N 19/186; H04N 19/159; H04N 19/176; H04N 19/593

(52) U.S. Cl. CPC H04N 19/186; H04N 19/159; H04N 19/176; H04N 19/593

(57) ABSTRACT

A video decoder may be configured to identify chroma blocks in received video data. The video decoder may determine from the received video data that DM intra prediction applies to the chroma blocks. The video decoder may retrieve data associated with luma blocks that correspond to the identified chroma blocks. The data associated with the luma blocks may indicate that DIMD, TIMD, IntraTMP, and/or SGMP are associated with the luma blocks. The video decoder, on condition that the received data indicates DM intra prediction applies to the chroma blocks and the data associated with the corresponding luma blocks indicate DIMD, and/or TIMD, IntraTMP, and/or SGMP are to be applied to the luma blocks, may determine that DIMD, and/or TIMD, IntraTMP, and/or SGMP may similarly be applied to the corresponding chroma blocks.

### CROSS-REFERENCE TO RELATED APPLICATIONS

This application claims the benefit of European Patent Application Number 22305489.1, filed Apr. 8, 2022, and European Patent Application Number 22307025.1, filed Dec. 23, 2022, the contents of all of which are hereby incorporated by reference herein in their entirety.

### BACKGROUND

Video coding systems may be used to compress digital video signals, e.g., to reduce the storage and/or transmission bandwidth needed for such signals.

### SUMMARY

Systems, methods, and instrumentalities are disclosed for decoding video data chroma blocks using the mode associated with the corresponding luma block on condition Direct Mode (DM) applies to the chroma blocks. If a chroma block may be in DM mode and the corresponding luma block may have applied to it Decoder side Intra Mode Derivation (DIMD), Template-based Intra Mode Derivation (TIMD), Intra Template Matching Prediction (IntraTMP), and/or Spatial Geometric Prediction Mode (SGPM), the chroma block likewise may have applied to it DIMD, TIMD, IntraTMP, and/or SGPM.

A video encoder may be configured to determine that chroma blocks may be encrypted and decrypted with the same intra prediction mode as the corresponding luma blocks. The video encoder may determine that the luma blocks and the corresponding chroma blocks may be processed using DIMD, TIMD, IntraTMP, and/or SGPM. The video encoder may generate encoded video data comprising an indication to process the chroma blocks using DM. The data may comprise a flag indicating to process the chroma blocks using DM. The video data may further comprise data indicating the corresponding luma blocks may be processed using DIMD, TIMD, IntraTMP, and/or SGPM. The video data may also comprise data indicating for the luma blocks, a Low-Frequency Non-Separable Transform (LFNST) index and/or a Multiple Transform Selection (MTS) index applies. The encoder may send the video data to a video decoder.

The video decoder may be configured to receive the video data and to determine or identify the chroma blocks. The video decoder may further determine from the received video data that the DM mode may be applied to the chroma blocks. For example, the video decoder may identify a flag indicating DM may be applied to the chroma blocks.

The video decoder may retrieve data from the video data for the luma blocks that correspond to the identified chroma blocks. The data associated with the luma blocks may indicate an intra prediction mode for the luma blocks. For example, the data associated with the luma blocks may indicate that DIMD, TIMD, IntraTMP, and/or SGPM are associated with and are to be applied to the luma blocks.

The video decoder, on condition that the received data indicates DM applies to the chroma blocks and the data associated with the corresponding luma blocks indicate DIMD, TIMD, IntraTMP, and/or SGPM are to be applied to the luma blocks, may determine that DIMD, TIMD, IntraTMP, and/or SGPM may similarly be applied to the corresponding chroma blocks. The video decoder may perform on the chroma blocks DIMD, TIMD, IntraTMP, and/or SGPM as specified in the data associated with the corresponding luma blocks. On condition that the received data further indicates for the luma blocks a LFNST index and/or an MTS index applies, the video decoder may apply to the corresponding chroma blocks the designated LFNST and/or MTS.

Systems, methods, and instrumentalities may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example block-based video encoder.

FIG. 3 illustrates an example video decoder.

FIG. 4 illustrates an example of a system in which various aspects and examples may be implemented.

FIG. 5 illustrates example intra prediction modes in VVC and ECM.

FIG. 6 illustrates example derivation of a Most Probable Modes (MPM) list.

FIGS. 7A and 7B illustrate example signaling of a selected intra prediction mode.

FIG. 8 illustrates example signaling of a selected intra prediction mode.

FIG. 9 illustrates an example Intra template matching search area.

FIG. 10 illustrates an example SGPM template analysis for candidate list construction.

FIG. 11 illustrates example processing for decoding chroma data using Direct Mode (DM) intra prediction and DIMD/TIMD.

### DETAILED DESCRIPTION

A more detailed understanding may be had from the following description, given by way of example in conjunction with the accompanying drawings.

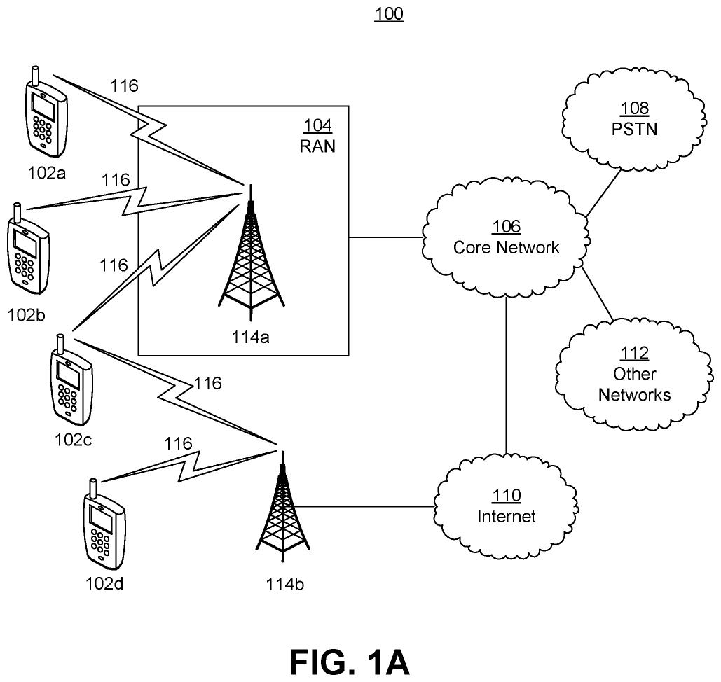

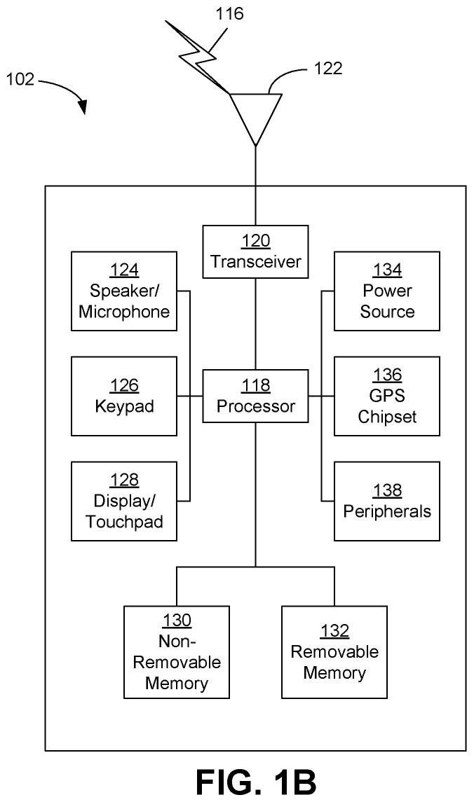

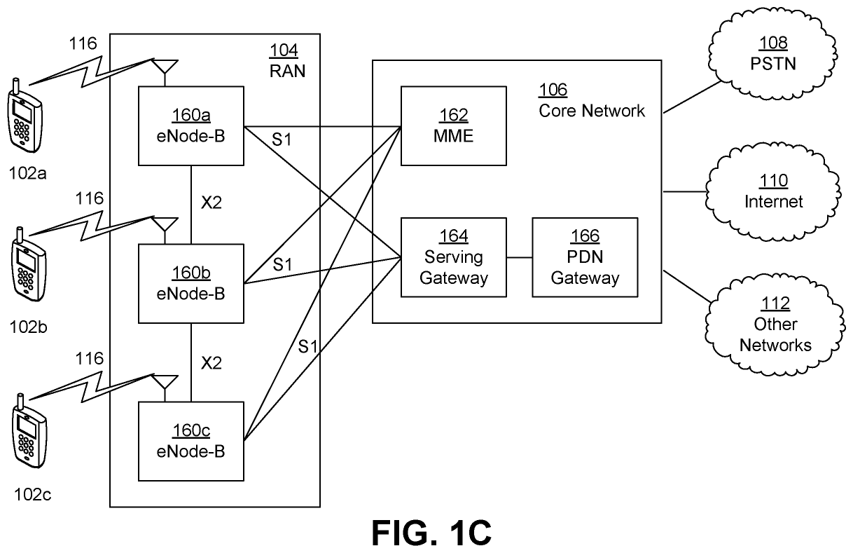

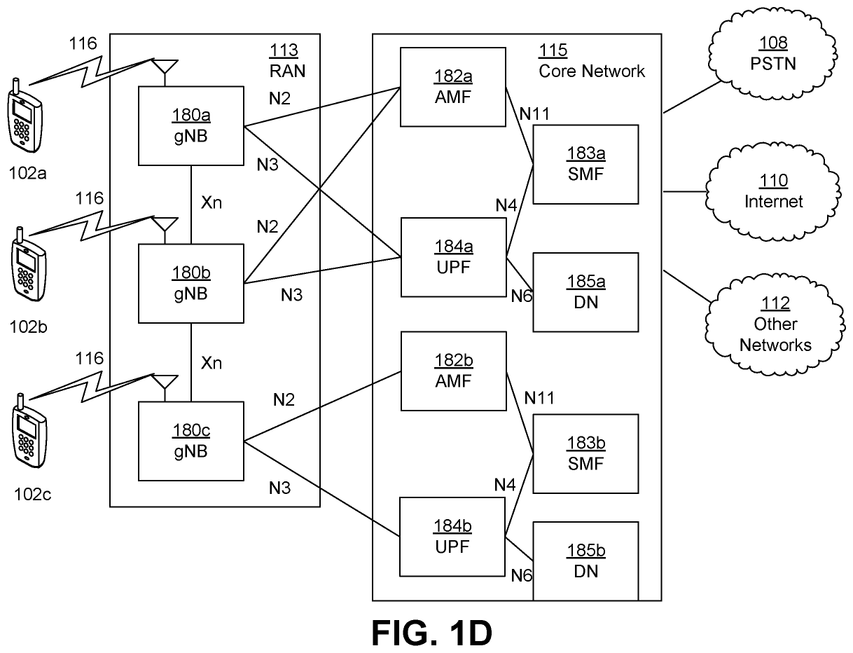

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

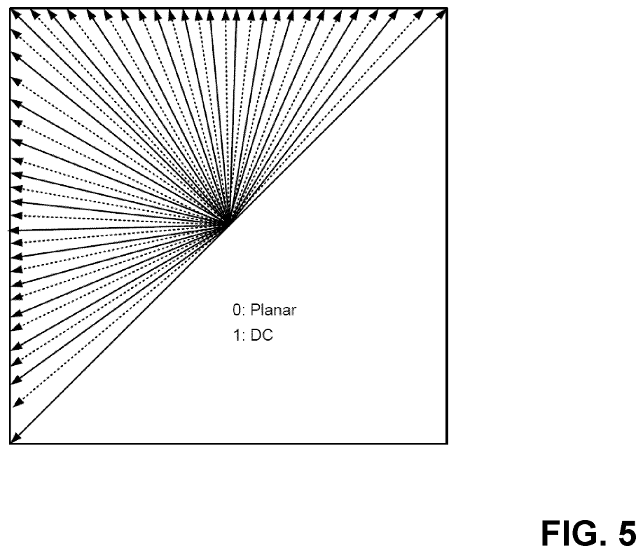

The aspects described and contemplated in this application may be implemented in many different forms. FIGS. 5-11 described herein may provide some examples, but other examples are contemplated. The discussion of FIGS. 5-11 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

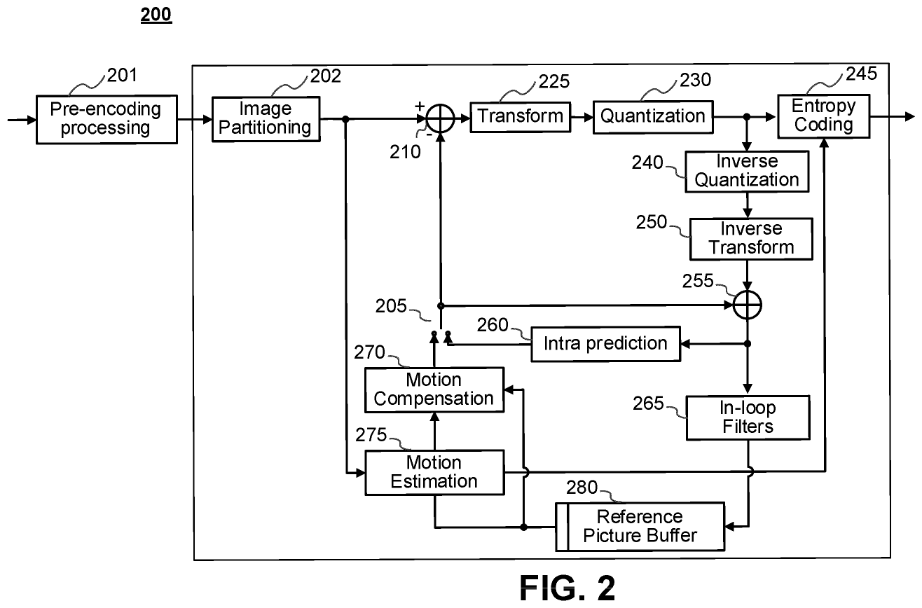

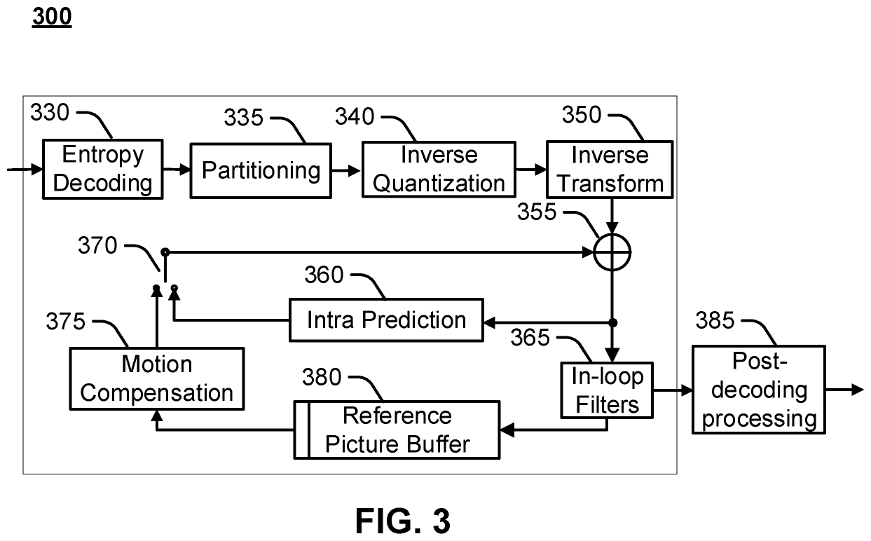

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples describing the present application for purposes of describing examples and the aspects described are not limited to these specific values.

FIG. 2 is a diagram showing an example video encoder. Variations of example encoder 200 are contemplated, but the encoder 200 is described herein for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing and attached to the bitstream.

In the encoder 200, a picture is encoded by the encoder elements as described herein. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder may skip the transform and apply quantization directly to the non-transformed residual signal. The encoder may bypass transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described herein. Video decoder 300 generally performs a decoding pass reciprocal to the encoding pass as described in FIG. 2. The encoder 200 also generally performs video decoding as part of encoding video data.

The input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing may use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

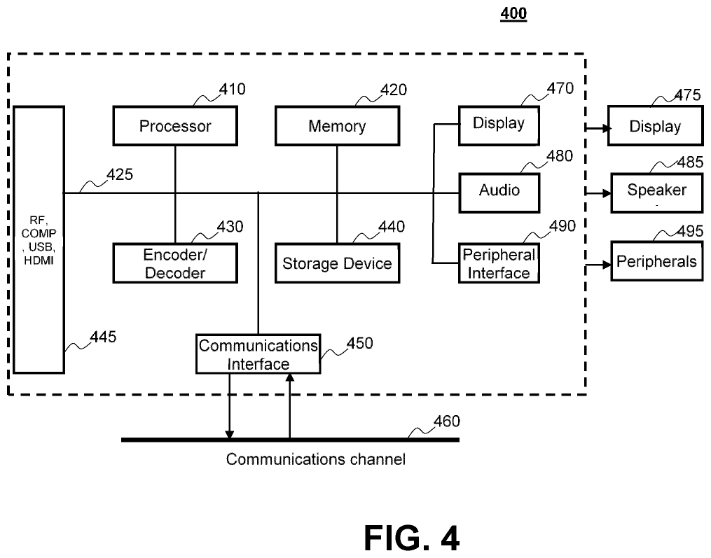

FIG. 4 is a diagram showing an example of a system in which various aspects and examples described herein may be implemented. System 400 may be embodied as a device including the various components described herein and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 may include embedded memory, input output interface, and various other circuitries as known in the art. The system 400 includes at least one memory 420 (e.g., a volatile memory device, and/or a non-volatile memory device). System 400 includes a storage device 440, which may include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 may include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 may include its own processor and memory. The encoder/decoder module 430 represents module(s) that may be included in a device to perform the encoding and/or decoding functions. As is known, a device may include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 may store one or more of various items during the performance of the processes described in this document. Such stored items may include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing. Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 may include, but is not limited to, a transceiver configured to transmit and to receive data over communication channel 460. The communication interface 450 may include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 may provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 may also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 may alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, may encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, applying to a chroma block, on condition the chroma block may be identified as being in DM, a prediction process associated with the corresponding luma block. As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, performing convolution(s), obtaining a latent vector, generating motion flow data, etc. In various examples, such processes also, or alternatively, include processes performed by an encoder of various implementations described in this application including, for example, determining that a chroma block may have applied to it the same prediction process as the corresponding luma block and include an indicator in the encoded video data.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on latent vectors, attention values, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, an indication of motion flow data, an indication of quantized motion flow data, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

Systems, methods, and instrumentalities are disclosed for encoding and decoding of video data chroma blocks using the mode associated with the corresponding luma block on condition Direct Mode (DM) applies to the chroma blocks. If a chroma block may be in DM mode and the corresponding luma block has applied to it Decoder side Intra Mode Derivation (DIMD), Template-based Intra Mode Derivation (TIMD), Intra Template Matching Prediction (IntraTMP), and/or Spatial Geometric Prediction Mode (SGPM), e.g., a prediction process, the chroma block may likewise have applied to it DIMD, TIMD, IntraTMP, and/or SGPM, e.g., the prediction process.

A video decoder may be programmed to receive video data and to determine or identify chroma blocks in the video data. The video decoder may determine from the received video data that direct mode (DM) intra prediction may be associated with the chroma blocks. For example, the video decoder may identify a flag in the video data indicating DM intra prediction may be applied to the chroma blocks.

The video decoder may retrieve data from the received video data for the luma blocks that correspond to the identified chroma blocks. The data associated with the luma blocks may indicate an intra prediction mode for the luma blocks. For example, the data may indicate that DIMD, TIMD, IntraTMP, and/or SGPM are associated with and are to be applied to the luma blocks. The video decoder, on condition that the received data indicates DM intra prediction applies to the chroma blocks and the data associated with the corresponding luma blocks indicate DIMD, TIMD, IntraTMP, and/or SGPM, e.g., a prediction process, are to be applied to the luma blocks, may determine that DIMD, TIMD, IntraTMP, and/or SGPM, e.g., the prediction process, may similarly be applied to the corresponding chroma blocks. The video decoder may perform intra prediction on the chroma blocks consistent with the intra prediction mode identified for the luma blocks and may perform DIMD, TIMD, IntraTMP, and/or SGPM on the chroma blocks as specified in the data associated with the corresponding luma blocks. On condition that the received data further indicates for the luma blocks a LFNST index or an MTS index, the video decoder may apply the designated LFNST and/or MTS to the corresponding chroma blocks.

The disclosed systems, methods, and instrumentalities may be applied in the context of video coding. The disclosed systems, methods, and instrumentalities may apply to the chroma Direct Mode (DM), where the chroma intra prediction mode may be similar to, e.g., the same as, the luma intra prediction mode. Systems, methods, and instrumentalities may employ Decoder side Intra Mode Derivation (DIMD), Template-based Intra Mode Derivation (TIMD), IntraTMP, and/or SGPM to chroma blocks on a condition that DIMD, TIMD, IntraTMP, and/or SGPM is applied to the corresponding luma block. If DM is used, transform indices that may be applied to a luma block may likewise be applied to the associated chroma blocks.

Intra prediction may be a, e.g., a fundamental, coding tool employed in hybrid video coding. For a given block to be predicted, an encoder may select an, e.g., a best, intra prediction mode in terms of rate-distortion and may signal its index of the intra prediction mode to the decoder so that, for the particular block, the decoder may perform the same prediction. Signaling the selected intra prediction mode index may add extra overhead and may reduce the gain from intra prediction. One manner of coding the index of the intra prediction mode selected to predict a given block may be to create a set of Most Probable Modes (MPMs). Employing a set of MPMs may reduce the signaling overhead if the index of the selected intra prediction mode belongs to that list. This method, e.g., classical method, for signaling the intra prediction mode index, which may be referred to, for example, as MPM list-based signaling, may be employed in WC and HEVC. MPM list-based signaling may be employed in ECM, where two MPM lists may be used rather than one. It will be appreciated that with respect to MPM list-based signaling, the signaling of a mode index may be shortened to refer to the signaling of a mode.

In HEVC, VVC, and ECM, the MPM list-based signaling may be, e.g., may only be, dedicated to the signaling of the intra prediction mode selected to predict a luma block. Chroma intra prediction mode signaling may differ from luma intra prediction mode signaling. In connection with chroma processing, signaling overhead may remain relatively small because, for a given pair of chroma blocks, e.g., gathering collocated Cb and Cr blocks, the selected intra prediction mode may be, e.g., may only be, either one of the following intra prediction modes: planar; DC; horizontal; vertical; or identical to the intra prediction mode selected to predict the luma block that is collocated with the particular pair of chroma blocks. Direct Mode (DM) may be said to apply in the instance the mode is identical to the intra prediction mode selected to predict the luma block that is collocated with the particular pair of chroma blocks. In VVC and ECM, for a given pair of chroma blocks, the selected intra prediction mode may also be a Cross-Component Linear Model (CCLM) mode.

In ECM, luma intra prediction may be augmented by two decoder side mode derivation methods: Decoder side Intra Mode Derivation (DIMD); and Template-based Intra Mode Derivation (TIMD). If a given pair of chroma blocks, e.g., collocated Cb and Cr blocks, may be coded using DM intra prediction mode and the luma block that is collocated with the pair of chroma blocks uses either TIMD or DIMD, the intra prediction mode for the pair of chroma blocks may be the same derived intra mode as specified in the data for the luma blocks. However, because under existing procedures DIMD/TIMD may not be applied for chroma blocks, applying DM to chroma blocks may limit the coding performance.

Systems, methods, and instrumentalities are disclosed herein to perform DIMD/TIMD for a given pair of chroma blocks if DM is selected and the luma block that is collocated with the pair of chroma blocks is coded with DIMD/TIMD. If DM is selected and the luma block follows the Multiple Transform Selection (MTS) and/or Low-Frequency Non-Separable Transform (LFNST), e.g., a transform process, the corresponding chroma blocks may likewise follow the MTS and/or LFNST, e.g., the transform process. This may enable chroma MTS and reduce chroma LFNST signaling.

Sixty-seven core intra prediction modes may be available. To capture the arbitrary edge directions presented in natural video, the number of directional intra prediction modes in VVC may be extended from 33, as used in HEVC, to 65. FIG. 5 depicts intra-prediction modes that may be used in VVC and ECM. The additional directional modes in VVC as compared to HEVC may be represented in FIG. 5 with dotted lines. As shown, the additional modes result in denser options of possible intra prediction modes. The denser directional intra prediction modes may apply for all block sizes and for luma and chroma intra predictions. In VVC, several conventional angular intra prediction modes may be adaptively replaced with wide-angle intra prediction modes for the non-square blocks.

From HEVC to VVC, the planar and DC modes may remain unchanged, excluding the following minor modification. In HEVC, intra-coded blocks, e.g., every intra-coded block, may have a square shape and the length of each of its sides may be a power of two. Accordingly, division operations may not be required to generate an intra-predictor using DC mode. In VVC, blocks may have a rectangular shape that allows for, e.g., necessitates, the use of a division operation per block in the general case. To avoid division operations for DC prediction, the longer side, e.g., only the longer side, may be used to compute the average for non-square blocks.

In ECM, a core structure of the sixty-seven intra prediction modes may be inherited from VVC. This core structure may be refined in ECM. The four-tap interpolation for a directional intra prediction mode may become a six-tap interpolation. Position Dependent Intra Prediction Combination (PDPC) may be supplemented with gradient PDPC.

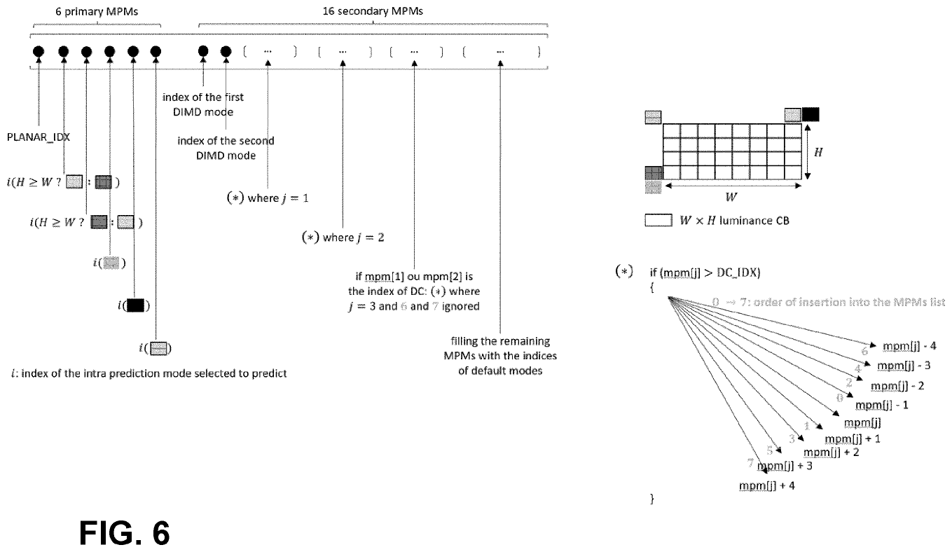

Intra prediction mode signaling may be supported by ECM. The intra prediction mode signaling may apply to luminance. In ECM, if the intra prediction mode selected to predict the current luminance Coding Block (CB) is neither DIMD, nor a Matrix-based Intra Prediction (MIP) mode, nor TIMD, e.g., it may be one of the 67 intra prediction modes mentioned herein, its index may be signaled using the MPM list of the CB. Pursuant to some procedures, Block Difference Pulse Code Modulation (BDPCM), Template-based Intra Prediction (TMP), Intra Block Copy (IBC), and Palette may be ignored as these tools may be activated for specific video sequences exclusively, e.g., screen content. In ECM, the generic MPM list may be decomposed into a list of six primary MPMs and a list of twenty-two secondary MPMs. FIG. 6 depicts example derivation of a generic MPM list for the current luminance CB belonging to an intra slide in ECM. The generic MPM list may be built by sequentially adding candidate intra prediction mode indices, from the candidate that is most likely to be the selected intra prediction mode for predicting the current luminance CB to the least likely candidate. FIG. 6 depicts, from left to right, a sequential addition of the candidate intra prediction mode indices in the case that the current luminance CB may belong to an intra slice. Redundancy may not exist in the generic list of MPMs, meaning that it may not contain two identical intra prediction mode indices. FIG. 6 illustrates an example where each candidate intra prediction mode index may be different from each other. However, in a generic example, the slots of indices 0 to i−1 that are included in the generic list of MPMs may have previously been filled. If the current candidate intra prediction mode index already exists in the current generic list of MPMs, the candidate may be skipped, and the next candidate intra prediction mode may be inserted at the slot of index i if it does not exist in the generic list of MPMs. Otherwise, the current intra prediction mode index may be inserted at the slot of index i and the next candidate intra prediction mode may be inserted at the slot of index i+1 if it does not exist in the generic list of MPMs.

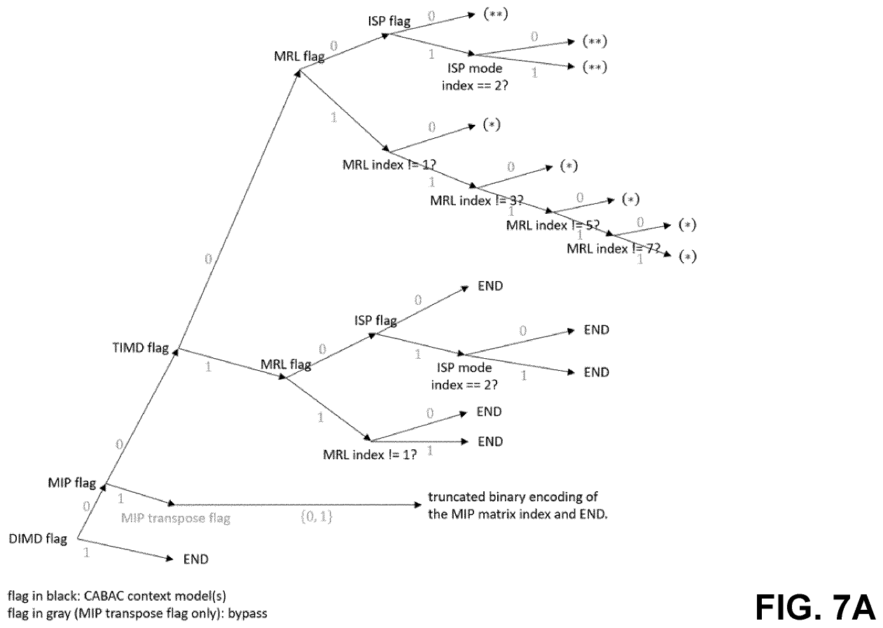

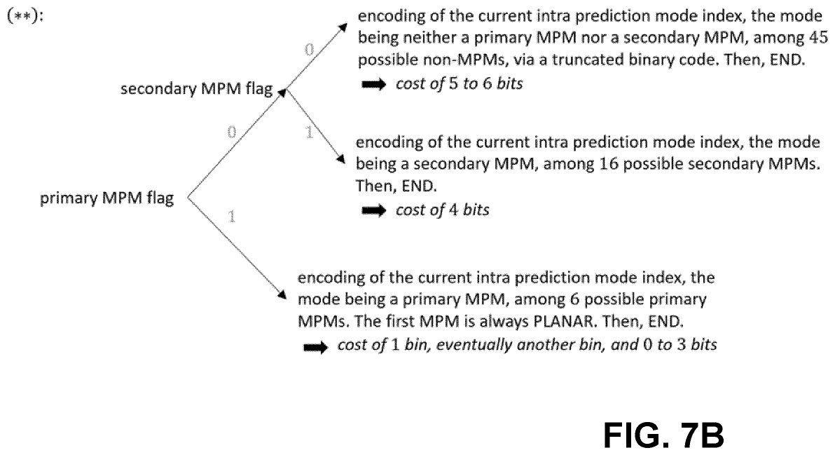

FIGS. 7A and 7B depict example signaling of the intra prediction mode selected to predict the current luminance CB in ECM. In the example signaling depicted in FIGS. 7A and 7B, the signaling may apply to encoder side processing. The example signaling may apply as well to decoder side processing. In FIGS. 7A and 7B, MRL may be used to denote Multiple Reference Lines. If the TIMD flag equals 1, the MRL index may belong to {0, 1, 3}. MRL index at 0 may indicate that MRL is not used for predicting the current luminance CB. MRL index at 1 may indicate that the second row of decoded reference samples above the current luminance CB and the second column of decoded reference samples on the left side of the current luminance CB may be used for prediction. MRL index at 3 may indicate that the fourth row of decoded reference samples above the current luminance CB and the fourth column of decoded reference samples on the left side of the current luminance CB may be used for prediction. If the TIMD flag equals 0, the MRL index may belong to {0, 1, 3, 5, 7, 12}. ISP denotes Intra Sub-Partition. The ISP mode index may belong to {0, 1, 2}. ISP mode index at 0 may indicate that ISP may not be used for the current luminance CB. ISP mode index at 1 may indicate that the current luminance CB may be split horizontally into luminance Transform Blocks (TBs). ISP mode index at 2 may indicate that the current luminance CB may be split vertically into luminance TBs. In FIGS. 7A and 7B, BDPCM, TMP, IBC, and Palette are omitted as these tools may be turned on for video sequences, e.g., specific video sequences, exclusively.

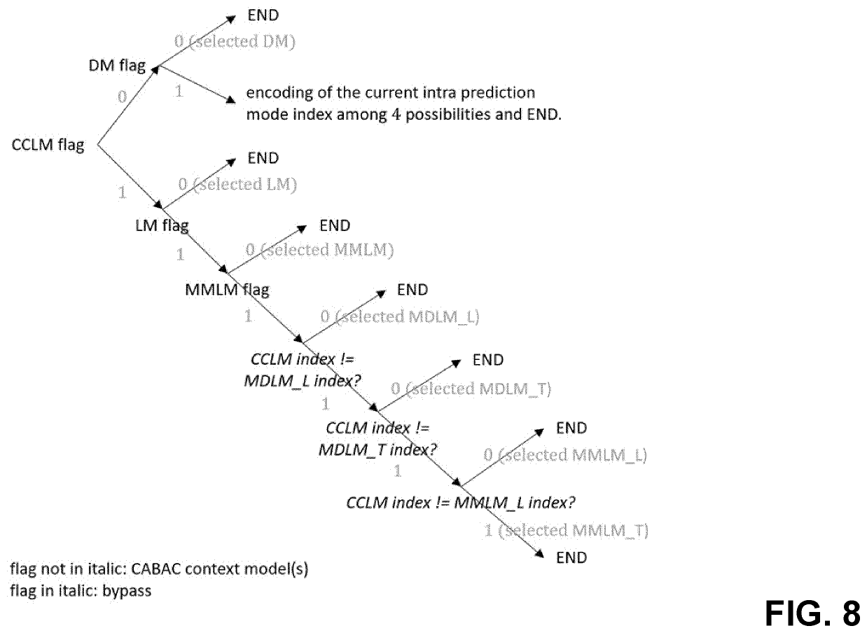

Intra prediction mode signaling in chrominance may be supported in ECM. FIG. 8 depicts example signaling of the intra prediction mode selected to predict the current pair of chrominance CBs, e.g., collocated Cb and Cr CBs, in ECM. In FIG. 8, if the DM flag equals 1, the four possibilities for the current intra prediction mode index may be the index of the planar mode, the horizontal mode, the vertical mode, and DC. To avoid redundancy, if the DM is one of the four above-mentioned modes, in this set of four modes, the index of the redundant mode may be replaced by the index of the vertical diagonal mode. In ECM, Cross-Component Linear Model (CCLM) may gather six different intra prediction modes, which may be denoted LM, MMLM, MDLM_L, MDLM_T, MMLM_L, and MMLM_T. In VVC, CCLM may gather three, e.g., only three, intra prediction modes.

Decoder side Intra Mode Derivation (DIMD) may be supported. For a given luminance CB to be predicted, DIMD may derive two intra prediction modes from the template of reconstructed neighboring samples surrounding a CB, and those two predictors may be combined with the planar mode predictor using the weights derived from the gradients in the template. The division operations in weight derivation may be performed utilizing the same lookup table (LUT) based integerization scheme used by the CCLM. For example, the division operation in the orientation calculation, Orient=G_{y}/Gₓ, may be computed by the following LUT-based scheme:

$$x = Floor ( Log 2 ( Gx ) )$$

$$normDiff = ( ( Gx ≪ 4 ) ≫ x ) \& 15$$

$$x += ( 3 + ( normDiff != 0 ) ? 1 : 0 )$$

$$Orient = ( {Gy}^{*} ( DivSigTable [ normDiff ] \vert 8 ) + ( 1 ≪ ( x - 1 ) ) ≫ x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

The two derived intra modes may be included into the generic MPM list. Consequently, for a given luminance CB to be predicted, the DIMD process may be performed before creating the MPM list. For a given luminance CB, the primary intra mode derived by DIMD may be stored and may be used for the MPM list construction of the neighboring luminance CBs.

IntraTMP in ECM may be supported. Intra template matching prediction, which may be referred to as Intra TMP or TMP, may be an intra prediction mode, e.g., a special intra prediction mode, that may copy a prediction block, e.g., the best prediction block, from the reconstructed part of the current frame, whose L-shaped template matches the current template. For a predefined search range, the encoder may search for a similar template, e.g., the most similar template, to the current template in a reconstructed part of the current frame and may use the corresponding block as a prediction block. The encoder may send information indicating that this mode is being used. The same prediction operation may be performed at the decoder side.

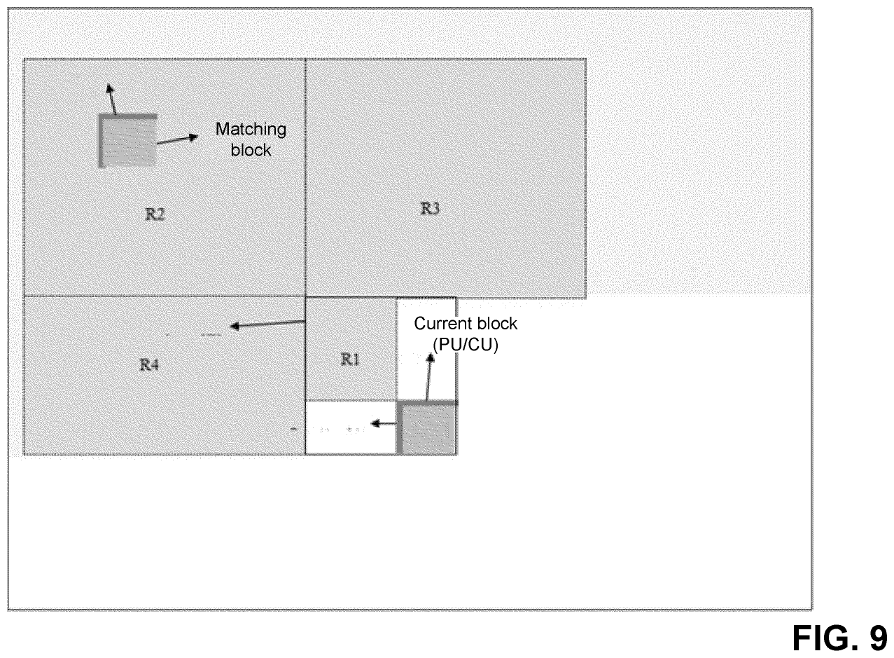

FIG. 9 depicts an example Intra template matching search area. The prediction signal may be generated by matching the L-shaped causal neighbor of the current block with another block in a predefined search area such as is depicted in FIG. 9. In the example depicted in FIG. 9, the search area may consist of the following: R1: current CTU; R2: top-left CTU; R3: above CTU; and R4: left CTU. SAD may be used as a cost function.

Within each region, the decoder may search for the template that may have SAD, e.g., the least SAD, with respect to the current one and may use its corresponding block as a prediction block.

The dimensions of regions, e.g. all regions, (SearchRange_w, SearchRange_h) may be set proportional to the block dimension (BlKW, BlkH) to have a fixed number of SAD comparisons per pixel. For example, SearchRange_w may be determined as follows: SearchRange_w=a*BlkW. SearchRange_h may be determined as follows: SearchRange_h=a*BlkH. With respect to both, ‘a’ may be a constant that controls the gain/complexity trade-off. For example, ‘a’ may be equal to 5.

The Intra template matching tool may be enabled for CUs with size less than or equal to, for example, 64 in width and height. This CU size, e.g., maximum CU size, for Intra template matching may be configurable.

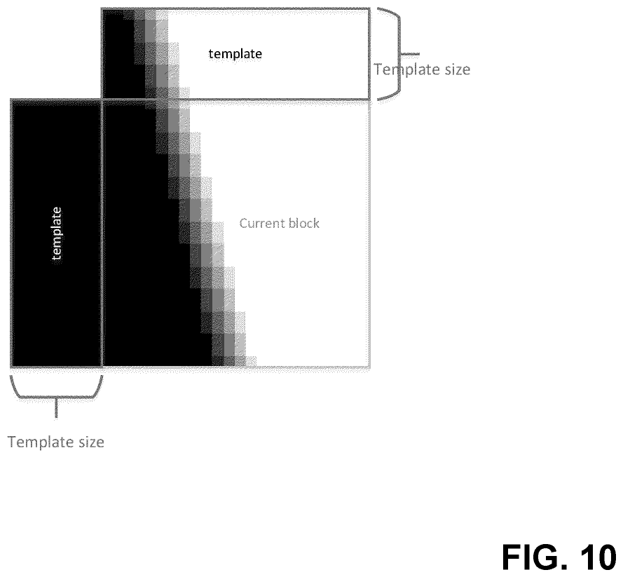

Spatial GPM (SGPM) in ECM may be supported. In this mode, several combinations of intra prediction modes and partitioning may be tested on the reconstructed template. FIG. 10 depicts example SGPM template analysis for candidate list construction.

In an example implementation, twenty-six (26) partitioning modes may be tested. For each partition, three intra prediction modes may be predefined. These modes may consist of an intra prediction mode parallel to the partition direction and two modes derived from a TIMD (template based intra mode derived) process. Overall, seventy-eight (e.g., 26×3=78) combinations may be considered (as noted Table 1 below). In each combination, the current partitioning may be used on the template, and each combination of two modes may be tested. That is, for three modes, three (3) modes may be tested (e.g., first mode and second, first mode and third and finally second and third). The distance (SATD) between the reconstructed template and the prediction with the current partitioning may be computed. The sixteen (16) candidates, e.g., best candidates, wherein each candidate may contain a partitioning mode and two intra prediction modes, may be retained and put in the SGPM candidate list. The encoder may send information identifying an index to indicate which of the candidates may have been selected depending on its rate-distortion analysis.

TABLE 1
SGPM combinations of Partitioning and Intra Modes

| | | IntraMode 1 | | |
|---|---|---|---|---|
| SGPM | Partitioning | (parallel to | IntraMode 2 | IntraMode 3 |
| combination | mode | partition) | (TIMD) | (TIMD) |
| 1 | P1 | I1 | T1 | T2 |
| 2 | P2 | I2 | T1 | T2 |
| . . . | . . . | . . . | . . . | . . . |
| 78 | P78 | I78 | T1 | T2 |

Fusion for Template-based Intra Mode Derivation (TIMD) may be supported. For the current luminance CB, for each intra prediction mode in its MPM list supplemented with default modes, the SATD between the prediction of the template of this CB via the particular mode and the reconstructed samples of the template may be calculated. The two intra prediction modes with the minimum SATDs may be selected as the TIMD modes. For TIMD, the set of directional intra prediction modes may be extended from 65 to 129, by inserting a direction between each arrow in FIG. 5. The set of possible intra prediction modes derived via TIMD may gather 131 modes. After retaining two intra prediction modes from the first pass of tests involving the MPM list supplemented with default modes, for each of these two modes, if this mode is neither PLANAR nor DC, TIMD may also test in terms of prediction SATD its two closest extended directional intra prediction modes. The two TIMD modes resulting from the two passes of tests may be fused with the weights after applying PDPC. Such weighted intra prediction may be used to code the current luminance CB. PDPC may be included in the derivation of the TIMD modes.

The costs of the two selected modes may be compared with a threshold. In the test, the cost factor of 2 may be applied as follows: costMode2<2*costMode1. If this condition is true, the fusion may be applied. Otherwise, mode1, e.g., only mode 1, may be used. Weights of the modes may be computed from their SATD costs as follows:

$$weight 1 = costMode 2 / ( costMode 1 + costMode 2 )$$

$$weight 2 = 1 - weight 1$$

The division operations may be conducted using the same lookup table (LUT) based integerization scheme used by the CCLM.

According to some procedures, chroma MTS may not be supported in VVC or ECM.

Chroma LFNST may be supported. LFNST may be applied to luma and chroma components. A CU flag, which may be named Ifnst_idx, may be signaled to indicate the usage of LFNST. LFNST may be, e.g., may only be, allowed for dual tree for a CU predicted in intra.

Systems, methods, and instrumentalities are disclosed for encoding and decoding of video data chroma blocks if Direct Mode (DM) intra prediction may be applied to the chroma blocks. If DM intra prediction is designated for one or more chroma blocks, the prediction information specified for the corresponding luma blocks may be applied to the chroma blocks. The intra prediction mode specified for the luma blocks is determined to apply to the chroma blocks. If the corresponding luma blocks are designated to be coded with DIMD and/or TIMD, the chroma blocks are likewise determined to be coded using DIMD and/or TIMD. Transform information associated with a luma block may be applied to the corresponding chroma block. An MTS index associated with a luma block may be applied to the chroma block and an LFNST index associated with the luma block may be applied to the corresponding chroma block.

A video encoder may be configured to determine that chroma blocks may be encrypted and decrypted with the same intra prediction mode as the corresponding luma blocks. The video encoder may further be configured to determine that the luma blocks and the corresponding chroma blocks may be processed using DIMD and/or TIMD. The video encoder may be configured to generate encoded video data comprising an indication to process the chroma blocks using DM intra prediction. The data may comprise a flag indicating to process the chroma blocks using DM intra prediction. The video data may further comprise data indicating the corresponding luma blocks may be processed using DIMD, TIMD, IntraTMP, and/or SGPM. The video data may also comprise data indicating for the luma blocks a Low-Frequency Non-Separable Transform (LFNST) index, a Multiple Transform Selection (MTS) index, and/or Multiple Reference Lines (MRL). The encoder may send the video data to the video decoder.

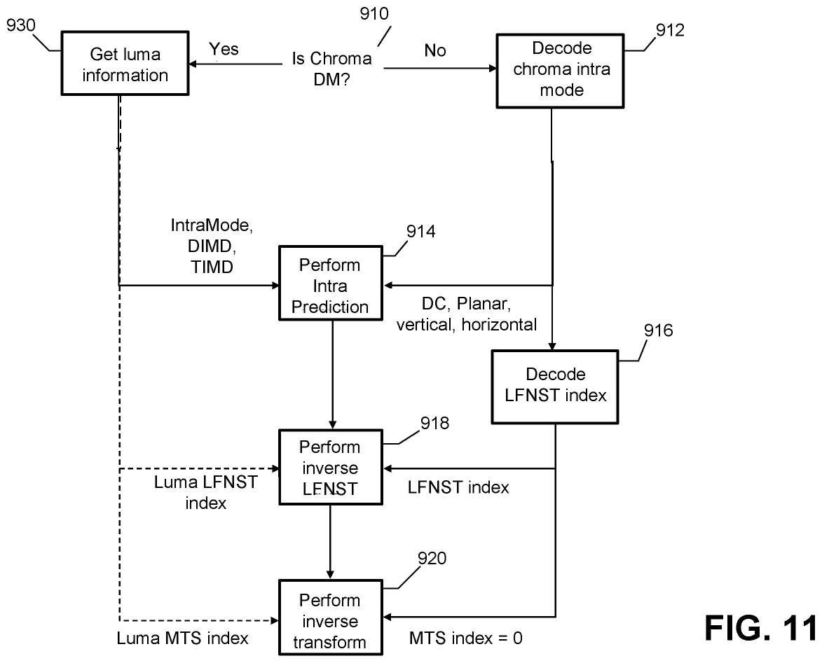

FIG. 11 depicts example processing of the sent data at a video decoder. The video decoder may be configured to receive the video data and to determine or identify chroma blocks in the video data. Referring to FIG. 11, at 910, the video decoder may determine from the received video data that direct mode (DM) intra prediction may be applied to the chroma blocks. For example, the video decoder may identify a flag in the video data indicating DM intra prediction may be applied to the chroma blocks.

If the video decoder determines DM intra processing does not apply to the particular chroma blocks, the decoder may determine at 912 to decode the chroma data using traditional chroma intra mode processing. As shown, the decoder may determine from the received video data the particular intra prediction mode that was used for encoding the chroma blocks. The decoder may determine which of DC mode, planar mode, vertical mode, or horizontal mode was used for coding the chroma blocks. At 914, the decoder may perform intra prediction using the identified one of the modes.

At 916, the decoder may decode Low-Frequency Non-Separable Transform (LFNST) index data from the received data. If direct mode (DM) does not apply, LFNST may be performed for chroma data if a flag, e.g., Ifnst_idx, is signaled to indicate LFNST may be applied to chroma data. At 918, the decoder may employ the LFNST index data to perform inverse LFNST using the output from the intra prediction at 914.

At 920, the decoder may perform inverse transform processing on the output from the LFNST processing at 918. In the instance that direct mode (DM) may not have been designated for use for a particular chroma block, the decoder may determine that Multiple Transform Selection (MTS) may not be used in processing the chroma block. Accordingly, as shown in FIG. 11, the decoder may determine an MTS Index is set to zero indicating MTS processing may not apply for the particular chroma block.

If at 910 the decoder determines from the received data that direct mode (DM) intra prediction mode applies for a received chroma block, decoder processing may continue using intra prediction data associated with the corresponding luma block. The decoder may perform the processing at 930, 914, 918, and 920 on condition that the decoder determines DM intra prediction mode applies for a chroma block. At 930, the decoder may retrieve intra prediction data associated with the corresponding luma block. As shown, the data for the corresponding luma block may identify an intra prediction mode for the luma block and may further identify whether Decoder side Intra Mode Derivation (DIMD) and/or Template-based Intra Mode Derivation (TIMD) applies to the luma block.

On condition that the received video data indicates DM intra prediction applies to the particular chroma block, at 914, the decoder may perform intra prediction of the particular chroma block using the retrieved data corresponding to the luma block. Accordingly, the decoder may apply to the chroma block the particular intra prediction mode designated for the corresponding luma block. If the retrieved data for the luma block indicates planar intra prediction mode applies, the decoder may perform intra prediction using the planar mode. If the retrieved data for the luma block indicates DC mode applies, the decoder may perform intra prediction using the DC mode. If the retrieved data for the luma block indicates horizontal mode applies, the decoder may perform intra prediction using the horizontal mode.

If the data for the luma block indicates DIMD or TIMD is to be applied, at 914 the decoder may apply the designated DIMD or TIMD to the particular chroma block. In processing associated with ECM, chroma DIMD may be employed. The same process used for luma DIMD processing may be applied for chroma processing. A flag, e.g., an additional flag, may be sent or signaled by the encoder to indicate that chroma DIMD is to be used. The flag may be signaled from the encoder to the decoder and may be retrieved from the received data at 930. The same method may be applied if chroma is coded with direct mode and luma is DIMD. DIMD for direct mode and may improve the overall bitrate gain.

Two example implementations may be considered. A first example implementation may use the chroma DIMD process, e.g., readily available chroma DIMD process, in ECM, which may derive the chroma mode from analyzing the luma for the 2 chroma channels. A second implementation may re-use the results of the luma DIMD. The luma DIMD process may derive two modes that may be combined with a planar mode using blending weights, e.g., predefined blending weights.

The first implementation may reuse the existing chroma DIMD architecture. However, the first implementation may be redundant with chroma DIMD signaling. In other words, there may be two (2) ways to signal chroma DIMD, one with chroma DIMD flag and the other with direct mode. Therefore, the second implementation may be considered where a prediction, e.g., new prediction, may be obtained by blending three (3) intra modes (e.g., two (2) derived modes and a planar mode).

TIMD may be enabled for a chroma block if the corresponding luma block is TIMD coded. Accordingly, if the data for the luma block indicates TIMD applies, at 914 the decoder may apply TIMD to the corresponding chroma block. Chroma TIMD coding may improve compression and may do so without additional signaling to that designated for luma processing. TIMD processing may be performed as described herein.

Two example implementations may be considered. A first example implementation may use the TIMD process to derive a chroma mode, e.g., the best chroma mode, by testing possible modes, e.g., all possible modes, on the reconstructed template and may select the one that minimizes the SATD between the reconstructed and predicted template. A second implementation may comprise re-using the derived TIMD modes from luma. The first implementation may be applied to both chroma components. However, the second implementation may have a benefit derived from re-using pre-computed modes and combining them with a pre-defined blending weight.

Referring to FIG. 11, the retrieved intra prediction data for the luma block may indicate (e.g., at 930) a Luma LFNST Index, e.g., a transform process. At 918, the decoder may apply the indicated LFNST for the chroma block. As noted in connection with 916, if direct mode (DM) does not apply, LFNST may be performed for chroma data if a flag, e.g., Ifnst_idx, is signaled for dual tree to indicate LFNST may be applied to chroma data. But if direct mode (DM) intra prediction applies, LFNST may be applied to the chroma data using a same index corresponding to the luma data. In this instance, the flag Ifnst_idx may not be signaled for LFNST to be applied to the chroma data.

The retrieved prediction data for the luma block may also indicate (e.g., at 930) a Luma MTS Index, e.g., a transform process. At 920, the decoder may perform inverse transform for the chroma block using the Luma MTS Index. MTS may be enabled for chroma if direct mode (DM) coding applies to the chroma data. The same transform pair selection for luma data may be used for chroma. In ECM, luma MTS may be block size and intra mode dependent. Chroma MTS may also be block size and intra mode dependent. However, that chroma may have sizes that may not be defined for transform. That is, chroma may go to 2×N, N×2 or 2×2. For these and similar cases, MTS may not be used, and DCT-II transform may be used, e.g., may alternatively be used.

It will be appreciated that MRL index data associated with luma blocks may also be used in chroma if direct mode (DM) applies to the chroma data. MRL may be enabled without additional signaling as the DM flag may be used to indicate MRL.

IntraTMP may be employed. If the collocated luma block uses IntraTMP (e.g., at 930), it may be determined to apply chroma IntraTMP in case of direct mode. The following implementations may be considered: recompute IntraTMP for chroma components (computing intra TMP for Cb and Cr; or computing them once); and reuse luma IntraTMP for chroma components. The first implementation may provide flexibility, e.g., the highest flexibility, which may lead to higher computational complexity compared to the second implementation.

SGPM may be employed. If the collocated luma block uses SGPM (e.g., at 930), it may be determined to apply SGPM in case of direct mode. The following implementations may be considered: recompute SGPM for chroma components (compute the best 2 intra modes and split line for each component, or both components); and reuse luma SGPM for chroma components (re-use the luma 2 intra mode and split line for each component). The first implementation may provide flexibility, e.g., the highest flexibility, which may lead to higher computational complexity compared to the second implementation.

A transform copy flag may be employed. A single flag, e.g., a direct mode flag, may be employed to signal transform and prediction information. The signaling may be decoupled and two flags may be used. The direct mode flag may be used for copying the luma intra prediction mode and a second flag may be used for copying the transform information. Employing two flags may provide the encoder with additional flexibility to select copying either prediction or transform information.

Although features and elements are described herein in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-49. (canceled)

50. A device for video decoding comprising:
a processor configured to:
obtain video data;
determine from the video data a chroma block;
determine, based on the video data, Direct Mode (DM) applies to the chroma block;
retrieve, based on a determination DM applies to the chroma block, data associated with a luma block associated with the chroma block, the data associated with the luma block indicating a decoder side derivation for an intra prediction mode; and
apply to the chroma block the decoder side derivation for an intra prediction mode.

51. The device of claim 50,
wherein the decoder side derivation for an intra prediction mode comprises Decoder side Intra Mode Derivation (DIMD).

52. The device of claim 50,
wherein the decoder side derivation for an intra prediction mode comprises Template-based Intra Mode Derivation (TIMD).

53. The device of claim 50, wherein the processor is further configured to:
retrieve, based on the determination DM applies to the chroma block, data associated with the luma block indicating a transform process; and
apply to the chroma block the transform process.

54. The device of claim 53, wherein the transform process is Multiple Transform Selection (MTS).

55. The device of claim 53, wherein the transform process is Low-Frequency Non-Separable Transform (LFNST).

56. A method of video decoding comprising:
obtaining video data;
determining from the video data a chroma block;
determining, based on the video data, Direct Mode (DM) applies to the chroma block;
retrieving, based on a determination DM applies to the chroma block, data associated with a luma block associated with the chroma block, the data associated with the luma block indicating a decoder side derivation for an intra prediction mode; and
applying to the chroma block the decoder side derivation for an intra prediction mode.

57. The method of claim 56,
wherein the decoder side derivation for an intra prediction mode comprises Decoder side Intra Mode Derivation (DIMD).

58. The method of claim 56,
wherein the decoder side derivation for an intra prediction mode comprises Template-based Intra Mode Derivation (TIMD).

59. The method of claim 56, further comprising:
retrieving, based on the determination DM applies to the chroma block, data associated with the luma block indicating a transform process; and
applying to the chroma block the transform process.

60. The method of claim 59, wherein the transform process is Multiple Transform Selection (MTS).

61. The method of claim 59, wherein the transform process is Low-Frequency Non-Separable Transform (LFNST).

62. A device for video encoding comprising:
a processor configured to:
obtain video data;
determine from the video data a chroma block;
determine, based on the video data, Direct Mode (DM) applies to the chroma block;
retrieve, based on a determination DM applies to the chroma block, data associated with a luma block associated with the chroma block, the data associated with the luma block indicating a decoder side derivation for an intra prediction mode; and
apply to the chroma block the decoder side derivation for an intra prediction mode.

63. The device of claim 62,
wherein the decoder side derivation for an intra prediction mode comprises one of Decoder side Intra Mode Derivation (DIMD) or Template-based Intra Mode Derivation (TIMD).

64. The device of claim 62, wherein the processor is further configured to:
retrieve, based on the determination DM applies to the chroma block, data associated with the luma block indicating a transform process; and
apply to the chroma block the transform process.

65. The device of claim 64, wherein the transform process is one or more of Multiple Transform Selection (MTS) or Low-Frequency Non-Separable Transform (LFNST).

66. A method of video encoding comprising:
obtaining video data;
determining from the video data a chroma block;
determining, based on the video data, Direct Mode (DM) applies to the chroma block;
retrieving, based on a determination DM applies to the chroma block, data associated with a luma block associated with the chroma block, the data associated with the luma block indicating a decoder side derivation for an intra prediction mode; and
applying to the chroma block the decoder side derivation for an intra prediction mode.

67. The method of claim 66,
wherein the decoder side derivation for an intra prediction mode comprises one of Decoder side Intra Mode Derivation (DIMD) of Template-based Intra Mode Derivation (TIMD).

68. The method of claim 66, further comprising:
retrieving, based on the determination DM applies to the chroma block, data associated with the luma block indicating a transform process; and
applying to the chroma block the transform process.

69. The method of claim 68, wherein the transform process comprises one or more of Multiple Transform Selection (MTS) or Low-Frequency Non-Separable Transform (LFNST).
